(19) United States
(12) Patent Application Publication
(10) Pub. No.: US 2004/0250901 A1
(43) Pub. Date: Dec. 16, 2004

(54) Collapsible stand

(76) Inventors: Mike Ursell, Berkley, MI (US); Timothy Hewitt, Pleasant Ridge, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/725,017

(22) Filed: Dec. 1, 2003

Related U.S. Application Data
(60) Provisional application No. 60/430,393, filed on Dec. 2, 2002.

(51) Int. Cl. B25H 1/00

(52) U.S. Cl. 144/286.1

(57) ABSTRACT

A pair of support brackets (36, 38) are spaced along and interconnect a pair of spaced and parallel support members (16, 18) and a pair of support legs (20, 22) are pivotally connected (28) to each support bracket (36, 38) for pivotal movement between a support position extending downwardly from said support members (16, 18) and a closed position underlying said support members (16, 18). A pair of wheels (48) may be removed from a pair of legs and rotatably supported on one of the support brackets (36, 38) for transport of the assembly in the folded position. Each of a pair of transverse rails (60) includes a C-shaped channel (71) facing the opposite rail (60) for supporting the opposite edges of a board (73). A support bar (107) is disposed in telescoping relationship within each of the support members (16, 18) for vertically supporting (106) a horizontal guide member (110).

### CROSS-REFERENCES TO RELATED APPLICATIONS

This application claims the benefit of provisional application Ser. Number 60/430,393 filed Dec. 2, 2002.

### BACKGROUND OF THE INVENTION

1. Field of the Invention

The present invention relates to a portable work-stand assembly of the type for supporting a tool to perform an operation on a work-piece supported by the stand.

2. Description of the Related Art

It is generally known to use sawhorses to support both a work piece and/or a tool for performing an operation on the work piece. Simple sawhorses may be constructed using commonly available wood sizes, such as 2×4's. The wood must be correctly sized and suitably connected together using fasteners, such as nails or screws. It has also been known to provide brackets for the insertion of wood pieces. The brackets allow the wood pieces to be fastened directly thereto to form the sawhorse.

It has also been known to provide portable sawhorses with collapsible or foldable legs, such that the sawhorse takes up less space when not being used or transported. Such portable sawhorses may be constructed from a suitable metal as illustrated in U.S. Pat. No. 5,119,903.

Yet other assemblies include rail members extending transversely to the length of the sawhorse for supporting various power tools, as illustrated in U.S. Pat. No. 5,626,321.

### BRIEF SUMMARY OF THE INVENTION AND ADVANTAGES

The subject invention provides a portable work-stand assembly that includes a pair of support brackets spaced along and interconnecting a pair of spaced support members. Each of the support brackets pivotally support a pair of support legs for pivotal movement between a support position extending downwardly from the support members and a closed position underlying the support members.

The spaced and parallel support members provide great versatility for supporting a wide variety of tools with easy attachment and removal of the tools from the support members. In addition, the support members facilitate the attachment of work-piece support guides from precisely positioning the work-piece relative to the tool.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a portable work-stand assembly shown supporting a work bench tool;

FIG. 2 is a fragmentary perspective view of an adjustable transverse support assembly of the portable work-stand assembly of FIG. 1;

FIG. 3 is a view taken along line 3-3 of FIG. 1 to illustrate the adjustable transverse support assembly of FIG. 2;

FIG. 4 is a perspective view of a portion of a work-piece stop;

FIG. 5 is a second perspective view of the portable work-stand assembly of FIG. 1 without a tool supported thereon;

FIG. 6 is a enlarged fragmentary perspective view of a second embodiment of an adjustable transverse support assembly;

FIG. 7 is a fragmentary view taken along line 7-7 of FIG. 6; and

FIG. 8 is an enlarged view similar to FIG. 3 showing an alternative embodiment of the adjustable transverse support assembly.

### DETAILED DESCRIPTION OF THE INVENTION

Referring to the Figures, wherein like numerals indicate like parts throughout the several views, a portable work stand assembly is generally shown at 10 for use with a bench top tool, generally shown at 12. The bench top tool 12 may be any type of mountable bench top tool 12; the miter saw 14 shown as an example being but illustrative of the various and many tools that can be supported on the work-stand assembly 10.

The portable work stand 12 includes a first support member 16 and a second support member 18. Each support member 16, 18 includes a first end 16A, 18A, and a second end 16B, 18B and are hollow tubular members of rectangular or square cross section. A first pair of support legs 20 is rotatably coupled to the first ends 16A, 18A of the support members 16, 18. A second pair of support legs 22 is rotatably coupled to the second ends 16B, 18B of the support members 16, 18. As shown, the first and second pairs of support legs 20, 22 are rotatable inwards (as shown by arrows 24, 26) towards a closed position. The closed position of the second pair of support legs 22 is shown in dotted lines in FIG. 5.

The first pair of support legs 20 is rotatable about a first pivot point 28 and the second pair of support legs 22 is rotatable about a second pivot point 30. In the illustrated embodiment, the first and second pivot points 28, 30, are defined by a fastener (such as a bolt or pin) which is inserted through apertures in each leg 20, 22 and a pair support brackets 36, 38, mounted to the first and second support members 20, 22. The pair of support brackets 36, 38 is spaced along and interconnects the support members 16, 18 by being welded or bolted to the support members 16, 18. The support brackets 36, 38 have flanges extending downwardly from the support members 16, 18 in an outwardly flaring manner or pyramidal fashion whereby the legs 20, 22 engage the flanges in the extended support position to diverge outwardly from one another in each pair and from one another in opposite pairs from the opposite ends of the support members 16, 18.

A pop-up button 40 on one or more of the legs 20, 22 may be used as a locking device to releasably lock the pair of legs 20, 22 in position. One or more apertures 32 may be located in the support brackets 36, 38 to releasably receive the buttons 40 and thereby releaseably hold legs 20, 22 in the respective extended support position and the closed or folded position.

The portable work stand may also include one or more wheel sub-assemblies 42 for rolling engagement with a support surface to transport the work-stand assembly (10). More specifically, the wheel sub-assemblies 42 support the work-stand assembly 10 in either of the support and folded positions for rolling engagement with a support surface to transport the work-stand assembly (10) in either of the support and folded positions.

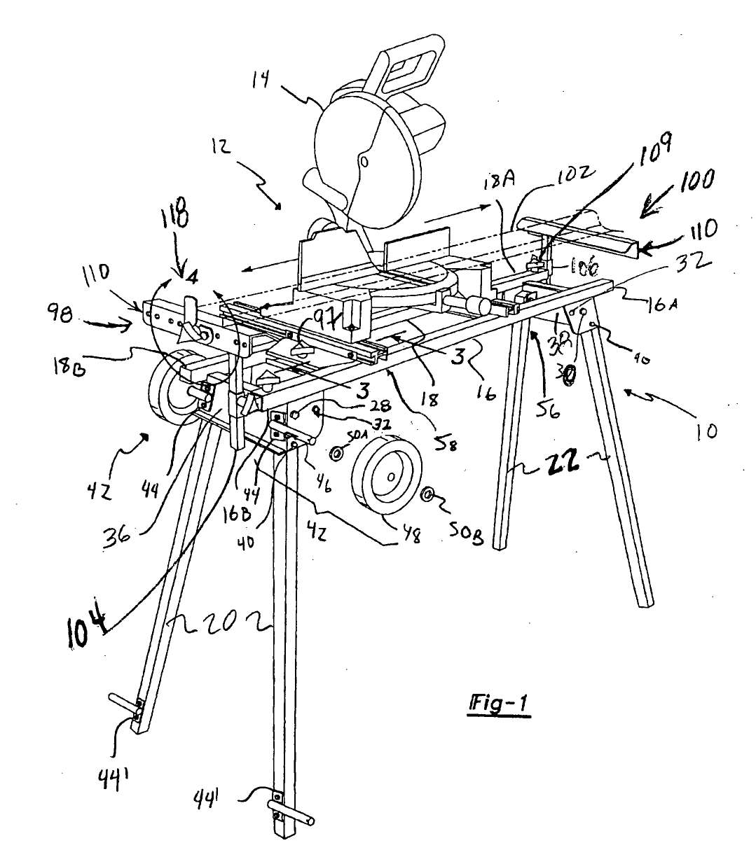

As shown in FIG. 1 and in phantom in FIG. 5, the wheel sub-assemblies 42 may be mounted on one of the leg support brackets 36, 38 for supporting the work-stand assembly 10 while in the folded position for rolling engagement with a support surface to transport the work-stand assembly (10) in the folded position. Each wheel sub-assembly 42 includes a mounting bracket 44 having an axle 46 mounted thereon. In one embodiment, the axle 46 is welded onto the bracket 44. The wheel sub-assembly 42 includes a wheel 48 and may include first and second washers 50A, 50B. The first washer 50A, the wheel 48, and the second washer 50B are located on the axle 46. A pin or clip 52 is located within an aperture 54 on the axle 46 to hold the wheel 48 and the washers 50A, 50B on the axle 46. The wheel sub-assemblies 42 may be used to move the portable work stand 10 when the portable work stand 10 is in the closed position. In one embodiment the support brackets 36, 38 are identical. In another embodiment, the support brackets 36, 38 are mirror images of each other.

Mounting brackets 44 may be additionally or alternatively located on the first or second pair of support legs 20, 22. In one embodiment, the wheels 48 may be moved from the mounting brackets 44 on the support bracket 36, 38 to the mounting brackets 44′ on the first or second pair of support legs 20, 22 (see FIG. 5). When the wheels 48 are located on the first or second pair of support legs 20, 22, the portable work stand 10 may be moved while in the open position. Alternatively, wheels 48 may be located on both sets of mounting brackets 44, 44′.

In one aspect of the invention, the portable work stand 10 may be provided with both sets of mounting brackets 44, 44′ and two sets of wheels 48 for mounting thereon. In another aspect of the invention, the portable work stand 10 may be provided with a single set of mounting brackets 44 which may be moved from the upper position (shown in FIG. 1) to the lower position (shown in FIG. 5).

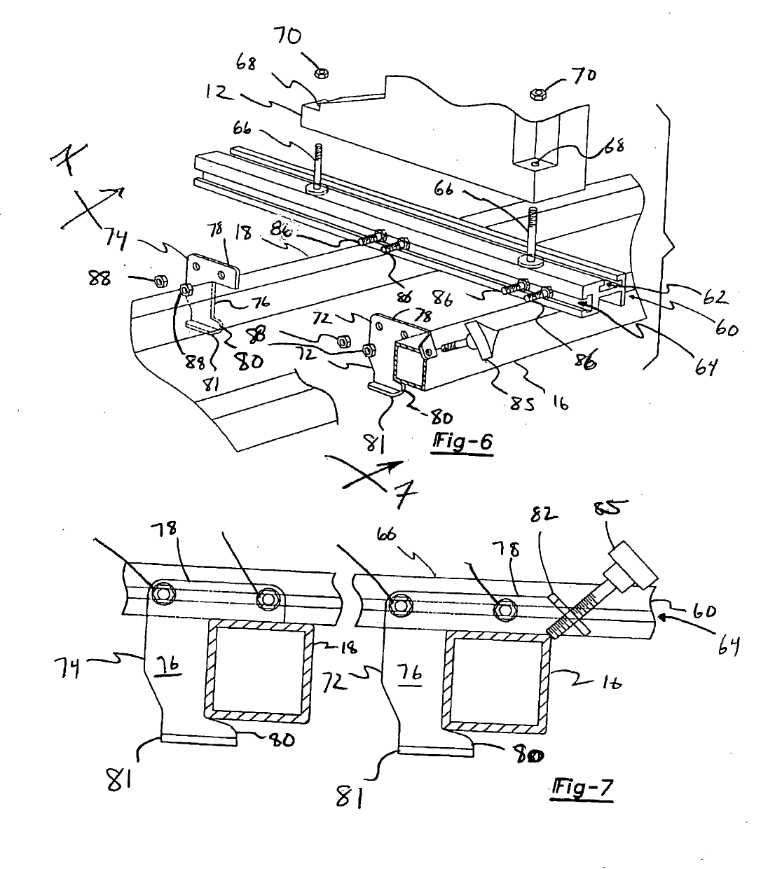

With reference to FIGS. 1, 6 and 7, the portable work stand 10 includes first and second adjustable transverse rail assemblies 56, 58. As discussed below, the first and second adjustable transverse rail assemblies 56, 58 are moveable in first and second directions along the first and second support members 16, 18 and are adjustable relative to one another to support and removably lock the bench top tool 12 in position. With particular reference to FIG. 6, the second adjustable transverse rail assembly 58 will now be explained. The first adjustable transverse rail assembly 56 being a mirror image of the second adjustable transverse rail assembly 58.

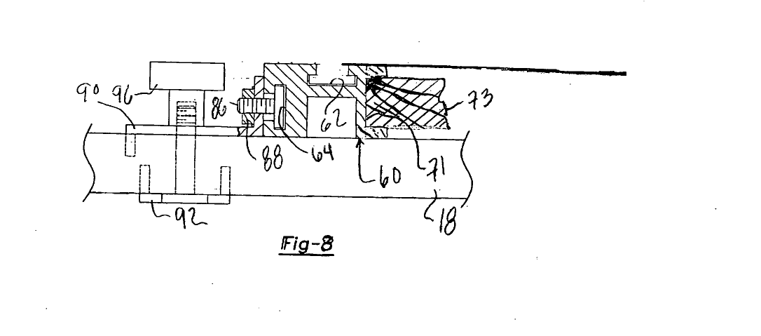

The second adjustable transverse rail assembly 58 includes a transverse rail 60 with a first channel 62 and a second channel 64. In one embodiment, the transverse rail 60 is composed from an extruded material, such as plastic, aluminum or other suitable material or alloy. The first channel 62 receives one or more threaded fasteners 66 which are inserted through apertures 68 located on the bench top tool 12. The bench top tool 12 may be mounted to the transverse rail 60 by one or more threaded nuts 70. An alternative embodiment of the rail 60 is shown in FIG. 8 wherein each of the rails 60 includes a C-shaped channel or groove 71 facing the opposite rail 60 for supporting the opposite edges of a wood board 73 therebetween. The use of a board 73 provides multi-purpose attachment, i.e., practically any attachment may be made to the board 73 by simply drilling attachment holes at the appropriate locations in the board 73.

The second adjustable transverse rail assembly 58 further includes first and second rail mounting brackets 72, 74. Each mounting bracket 72, 74 includes a central portion 76 and first and second flanges 78, 80. The central portion 76 and the first and second flanges 78, 80 fit around the first or second support member 16, 18, as shown. A transverse flange 82 on one of the mounting brackets 72, 74 includes a threaded aperture 84 for receiving a threaded fastener 85 for locking the transverse rail 60 in position. In one embodiment, the threaded fastener 85 is positioned at a corner of the support member 16 such that the threaded fastener 85 engages the corner. In another embodiment the threaded fastener 85 engages a side of the support member 16. Accordingly, a mounting bracket includes a pair of brackets 72, 74 and a clamping device 85 for clamping the support members 16, 18 therebetween. The pair of brackets 72, 74 and the clamping device 85 are oriented to clamp the support members 16, 18 horizontally therebetween in a direction parallel to a plane containing the support members 16, 18.

The first flange 78 includes at least one aperture for receiving a threaded fastener 86 located in the second channel 64. Threaded nuts 88 are threaded onto the threaded fasteners 86 for mounting the transverse rail 60 to the mounting brackets 72, 74. The second flange 80 may also include a horizontal flange 81 which acts as feet. This allows the first and second adjustable transverse rail assemblies 56, 58 to be removed from the portable work stand 10 along with the tool 12. The first and second adjustable transverse rail assemblies 56, 58 and the tool 12 may then be positioned on the floor or another table without have to remove the first and second adjustable transverse rail assemblies 56, 58. In another aspect of the present invention, the horizontal flanges 81 may be provided with adjustable or self-leveling feet (not shown).

Alternatively, the threaded fasteners 66, 85, 86, 108, 128 may be replaced with quick release couplers.

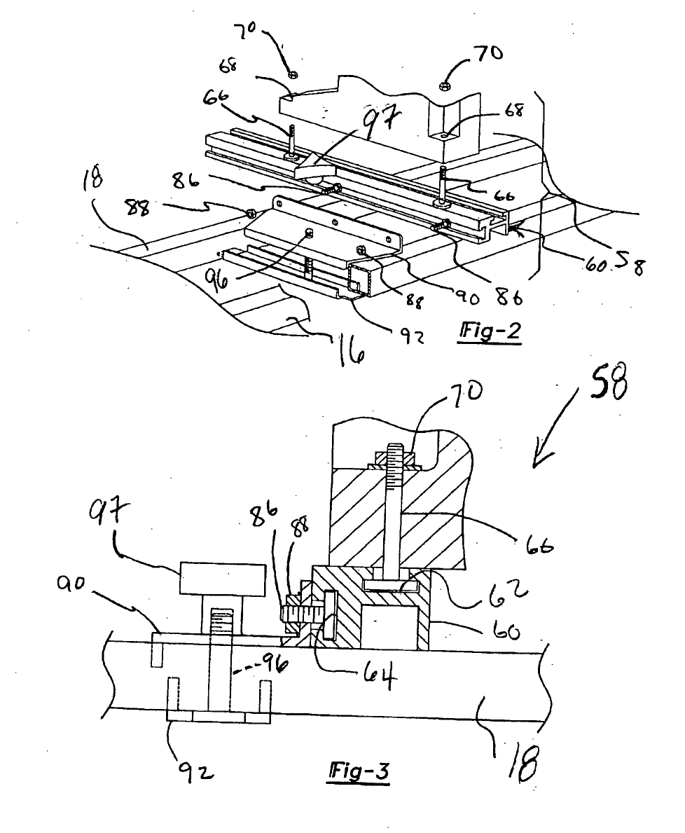

In an alternate embodiment, as shown in FIGS. 2 and 3, each adjustable transverse rail assembly 56, 58 includes an upper mounting bracket 90 and a lower mounting bracket 92. The upper mounting bracket 90 includes a transverse flange 92 with one or more apertures 94 for receiving the fasteners 86. The upper and lower mounting brackets 90, 92 are releasable connected by a fastener 96 and a threaded nut or knob 97. The fastener 96 may be loosened so that the adjustable transverse rail assembly 60 may be adjusted to a suitable position to handle a variety of bench top tools 12. Accordingly, a mounting bracket includes a pair of brackets 90, 92 and a clamping device 96, 97 for clamping the support members 16, 18 therebetween. The pair of brackets 90, 92 and the clamping device 96, 97 are oriented to clamp the support members 16, 18 vertically therebetween in a direction perpendicular to a plane containing the support members 16, 18.

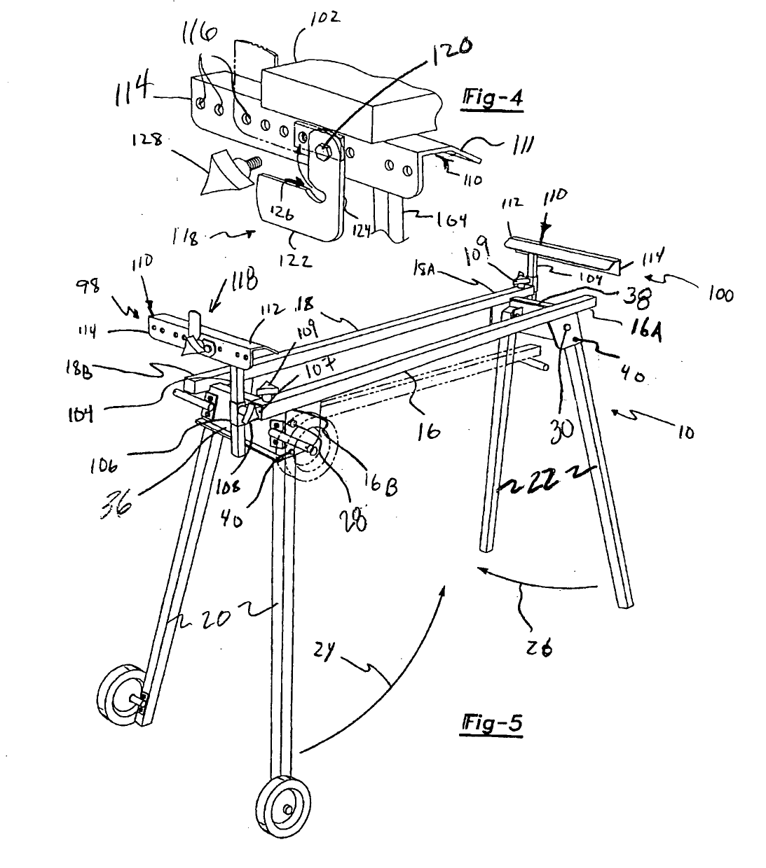

With particular reference to FIGS. 1 and 4, the portable work stand 10 includes first and second adjustable work-piece support assemblies 98, 100 for supporting a work-piece 102 (shown in dotted lines). Each support assembly 98, 100 includes a horizontal guide member 110 and an adjustment mechanism for adjusting the vertical and horizontal position of the guide member 110 relative to the support members 16, 18. More specifically, each support assembly 98, 100 includes a vertical support member or bar 104 which is coupled to one of the first and second support members 16, 18 via a bracket 106. The bracket 106 is supported on the end of a support bar 107 that is slideably disposed in telescoping relationship within one of the hollow support members 16 or 18. A threaded fastener 108 with a knob is inserted into an aperture of the bracket 106 to allow the vertical height of the guide member 110 of the support assembly 98, 100 to be adjusted, i.e., the fastener 108 clamps the vertical support member 104 within the bracket 106 which surrounds the vertical support member 104. In a similar fashion, a threaded fastener 109 with a knob is inserted into an aperture of the support member 16 or 18 to allow the horizontal position of the guide member 110 of the support assembly 98, 100 to be adjusted, i.e., the inner support bar 107 slides in and out of one of the support members 16 or 18 and is clamped in position by the fastener 109. Therefore, the fasteners 108 and 109 define clamping devices for adjustably positioning and clamping the respective bars 104 and 107. The support assemblies 98, 100 further include a horizontal support or guide 110 having a support flange 112 and a side flange 114 coupled to the vertical support member 104, the side flange having a plurality of holes 116 therealong. The support flange 112 defines an upper support surface for supporting the work-piece 102. A ramped flange 111 may also be included to allow the work piece 102 to be slid up the ramped flange 111 to the support flange 112, i.e., the horizontal guide member 110 has an upper support surface 112 and the ramp 111 guides a work-piece 102 up and onto the upper support surface 112.

A work-piece stop 118 may be rotatably coupled to the side flange 114 of one or both of the first and second adjustable work-piece support assemblies 98, 100. The work-piece stop 118 is rotatably connected to the side flange 114 by a fastener 120. The fastener 120 attaches the stop 118 at anyone of various positions defined by the holes 116 along the guide member 110. The stop 118 is rotatable between a first position and second position (shown in dotted lines in FIG. 4). The stop 118 pivots about the fastener 120 and includes a first portion 122 and a second portion 124. The first and second portions 122, 124 are separated by a notch 126. The stop 118 may be locked into the second position by a threaded fastener 128 inserted into an aperture 120 in the side flange 114. When the stop 118 is not needed, it may be moved to the first position. Accordingly, the fastener 120 is disposed in the second portion 124 for allowing the first portion 122 of the stop 118 to rotate between an extended position above the guide member (110) and a retracted position (as shown in phantom in FIG. 4) below the guide member 110. The clamping fastener 128 extends through the notch 126 in the extended position to clamp the stop 118 against the guide member 110.

The stop 118 may be used to keep the work-piece102 in a desired position while it is being worked on. In order to use the stop 118, the threaded fastener 108 is loosened and the stop 118 is pivoted such that the first portion 122 is above the side flange 114. The work-piece stop 118 may be used in several ways. First, a side of the work-piece102 may be placed adjacent an edge of the first portion 122 to limit movement of the work-piece102 in a direction transverse to the first and second support members 16, 18 (as shown in FIG. 4). Alternatively, an end of the work-piece 102 may be placed against an inner surface of the first portion 122 to limit movement of the work-piece102 in a direction along the first and second support members 16, 18.

As described above, the first and second transverse rail assemblies 56, 58 may be adjusted along the support members 16, 18. In use, this allows various tools 12 which may have different sizes to be mounted to the work stand 10. Additionally, the tool 12 may be positioned at an infinite number of positions along the support members 16, 18.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. In addition, the reference numerals in the claims are merely for convenience and are not to be read in any way as limiting.

What is claimed is:

1. A portable work-stand assembly comprising;
a pair of spaced support members (16, 18),
a pair of support brackets (36, 38) spaced along and interconnecting said support members (16, 18),
a first pair of support legs (20) pivotally connected (28) to said first support bracket (36) for pivotal movement between a support position extending downwardly from said support members (16, 18) and a closed position underlying said support members (16, 18),
a second pair of support legs (22) pivotally connected (30) to said second support bracket (38) for pivotal movement between a support position extending downwardly from said support members (16, 18) and a folded position underlying said support members (16, 18).

2. An assembly as set forth in claim 1 including at least one wheel sub-assembly (42) for rolling engagement with a support surface to transport said work-stand assembly (10).

3. An assembly as set forth in claim 1 including at least one wheel sub-assembly (42) for supporting said work-stand assembly (10) in either of said support and folded positions for rolling engagement with a support surface to transport said work-stand assembly (10) in either of said support and folded positions.

4. An assembly as set forth in claim 1 including at least one wheel sub-assembly (42) for supporting said work-stand assembly (10) in said folded position for rolling engagement with a support surface to transport said work-stand assembly (10) while in said folded position.

5. An assembly as set forth in claim 4 wherein said wheel sub-assembly (42) includes a pair of wheels (48) rotatably supported on one of said support brackets (36, 38).

6. An assembly as set forth in claim 1 including a pair of transverse rail assemblies (56, 58) extending across said support members (16, 18).

7. An assembly as set forth in claim 1 including a pair of transverse rail assemblies (56, 58) extending across and adjustable along said support members (16, 18) relative to one another.

8. An assembly as set forth in claim 7 wherein each transverse rail assembly (56, 58) includes a rail (60) and at least one mounting bracket (72, 74 or 90, 92) for adjustably connecting said transverse rail to said support members (16, 18).

9. An assembly as set forth in claim 8 wherein said mounting bracket (72, 74) includes a pair of brackets (72, 74 or 90, 92) and a clamping device (85 or 96, 97) for clamping said support members (16, 18) therebetween.

10. An assembly as set forth in claim 9 wherein said pair of brackets (72, 74) and said clamping device (85) are oriented to clamp said support members (16, 18) horizontally therebetween in a direction parallel to a plane containing said support members (16, 18).

11. An assembly as set forth in claim 9 wherein said pair of brackets (90, 92) and said clamping device (96, 97) are oriented to clamp said support members (16, 18) vertically therebetween in a direction perpendicular to a plane containing said support members (16, 18).

12. An assembly as set forth in claim 8 wherein each of said rails (60) includes a C-shaped channel (71) facing the opposite rail (60) for supporting the opposite edges of a board (73) therebetween.

13. An assembly as set forth in claim 1 including a work-piece support assembly (98, 100) extending longitudinally from said support members (16, 18).

14. An assembly as set forth in claim 13 wherein said work-piece support assembly (98, 100) includes a horizontal guide member (110) and an adjustment mechanism for adjusting the vertical and horizontal position of said guide member (110) relative to said support members (16, 18).

15. An assembly as set forth in claim 13 wherein said work-piece support assembly (98, 100) includes a horizontal guide member (110) and an adjustment mechanism for adjusting the horizontal position of said guide member (110) relative to said support members (16, 18).

16. An assembly as set forth in claim 15 wherein adjustment mechanism includes a support bar (107) disposed in telescoping relationship with one of said support members (16, 18).

17. An assembly as set forth in claim 16 wherein said support members (16, 18) are hollow and said support bar (107) is disposed in telescoping relationship within one of said support members (16, 18).

18. An assembly as set forth in claim 17 including a clamping device (109) for adjustably clamping said support bar (107) to said support member (16 or 18).

19. An assembly as set forth in claim 13 wherein said work-piece support assembly (98, 100) includes a horizontal guide member (110) and a work-piece stop (118) for limiting movement of a work-piece relative to said guide member (110).

20. An assembly as set forth in claim 19 including a fastener (120) for attaching said stop (118) at anyone of various positions along said guide member (110).

21. An assembly as set forth in claim 20 wherein said stop (118) includes first (122) and second (124) portions separated by a notch (126), said fastener (120) being disposed in said second portion (124) for allowing said first portion (122) of said stop (118) to rotate between an extended position above said guide member (110) and a retracted position below said guide member (110), and a clamping fastener (128) extending through said notch (126) in said extended position to clamp said stop (118) against said guide member (110).

22. An assembly as set forth in claim 13 wherein said work-piece support assembly (98, 100) includes a horizontal guide member (110) having an upper support surface (112) and a ramp (111) for guiding a work-piece up and onto said upper support surface (112).

23. An assembly as set forth in claim 1 including a locking device (40) for locking said legs (20, 22) in at least one of said support and folded positions.

24. A portable work-stand assembly comprising;
a pair of spaced support members (16, 18),
a pair of support brackets (36, 38) spaced along and interconnecting said support members (16, 18),
a first pair of support legs (20) connected (28) to said first support bracket (36) and extending downwardly from said support members (16, 18),
a second pair of support legs (22) pivotally connected (30) to said second support bracket (38) and extending downwardly from said support members (16, 18), and
a work-piece support assembly (98, 100) extending longitudinally from said support members (16, 18).
